(19) United States
(12) Patent Application Publication
(10) Pub. No.: US 2026/0358866 A1
(43) Pub. Date: Nov. 12, 2026

(54) PANEL STRUCTURE OF COMPUTER CASE

(71) Applicant: Chien-Hao CHEN, Keelung City (TW)

(72) Inventor: Chien-Hao CHEN, Keelung City (TW)

(21) Appl. No.: 19/446,018

(22) Filed: Jan. 12, 2026

(30) Foreign Application Priority Data
May 7, 2025 (TW) 114117219

(51) Int. Cl. G06F 1/18

(52) U.S. Cl. CPC G06F 1/181

(57) ABSTRACT

A front panel structure of a computer case is provided, which comprises a light-transmissive panel body having through holes, a plurality of covers for closing each of the through holes on the outer surface of the panel body, and a cooling fan module. Each cover is provided with fastening members and ventilation holes. The cooling fans of the cooling fan module are sequentially located on the inner surface of the panel body and respectively aligned opposite each of the through holes. Each cooling fan is disposed with fastening portions on a lateral side of the inner surface of the panel body, so that when the fastening members of each cover are securely connected to the fastening portions of the cooling fan on another side of the through hole, the cooling fans and the covers could be stably positioned on the panel body.

### FIELD OF THE INVENTION

The present invention is related to a front panel structure of a computer case that features a simple structure, low cost, easy assembly, and improved internal heat dissipation efficiency, particularly suitable for use in desktop computers.

### BACKGROUND OF THE INVENTION

In recent years, computer devices have evolved at a rapid pace. As technology advances, their applications are ubiquitous, giving rise to what we now call computers. Computers have a variety of executive, computing functions to meet people's needs. Personal computers serve entertainment, word processing, and media playback functions in household settings. Industrial computers provide control, monitoring, and computational services for factory operations. Automotive computers offer multimedia entertainment for drivers and passengers, along with real-time information reception. Overall, computers have become indispensable devices in human society.

Existing computers and servers utilize chassis to accommodate electronic components, and computers or CPUs or graphics cards would generate waste heat during operation. Although high-performance or high-end CPUs and graphics cards are equipped with cooling devices such as heat sinks or fans to dissipate heat, there is still a risk of thermal shutdowns or component damage if the temperature inside the chassis is not expelled effectively.

Currently, the existing solutions involve adding external cooling devices to the chassis to draw in external cool air and direct it toward internal heat sources. However, existing cooling fans are typically fixed to the rear of the chassis, limiting their heat dissipation effectiveness.

### SUMMARY OF THE INVENTION

The primary object of the present invention is to provide a front panel structure of a computer case that is simple in design, low in cost, easy to assemble, and enhances internal heat dissipation efficiency in the computer case.

In order to achieve the object of the invention, the present invention provides a front panel structure of a computer case configured to be assembled and integrated with a front side of the computer case to form a computer case structure. The front panel structure comprises a light-transmissive panel body, a plurality of covers, and a cooling fan module. The light-transmissive panel body has an outer surface and an inner surface and is provided with a plurality of through holes, and each of the through holes penetrates the outer surface and the inner surface of the panel body. The plurality of covers respectively close each of the through holes on the outer surface of the light-transmissive panel body, and each of the covers is provided with a plurality of fastening members and a plurality of ventilation holes. The cooling fan module has a plurality of cooling fans, and each of the cooling fans is sequentially located on the inner surface of the light-transmissive panel body and respectively aligned opposite each of the through holes, wherein each cooling fan is disposed with a plurality of fastening portions on a lateral side of the inner surface of the light-transmissive panel body, so that when the fastening members of each cover are securely connected to the fastening portions of the cooling fan on another side of the through hole, the cooling fans and the covers would be stably positioned on the light-transmissive panel body to allow airflow generated by the cooling fans after starting to flow in and out through the through holes and the covers.

In implementation, the fastening portions of each cooling fan are holes, and the fastening members of each cover are hooks.

In implementation, an elastic member is provided between each fastening portion of the cooling fan, and when each cooling fan is mounted on the inner surface of the light-transmissive panel body, the elastic members could closely attach to the inner surface of the light-transmissive panel body surrounding the through holes.

In implementation, a diameter of each cover is greater than a diameter of each through hole.

For further understanding the characteristics and effects of the present invention, some preferred embodiments referred to drawings are in detail described as follows.

### BRIEF DESCRIPTION OF DRAWINGS

FIG. 1 is a schematic diagram illustrating the state of the front panel structure and the computer case prior to assembly in an embodiment of the present invention.

FIG. 2 is an exploded perspective view of the front panel structure of the computer case in an embodiment of the present invention.

FIG. 3 is a partially enlarged schematic diagram of the cooling fans in an embodiment of the present invention.

FIG. 4 is a schematic diagram illustrating the state of the cover and the light-transmissive panel body prior to assembly in an embodiment of the present invention.

FIG. 5 is a schematic diagram illustrating the state of the front panel structure and the computer case after assembly in an embodiment of the present invention.

FIG. 6 is a front view of the front panel structure and the computer case after assembly in an embodiment of the present invention.

### DETAILED DESCRIPTIONS OF PREFERRED EMBODIMENTS

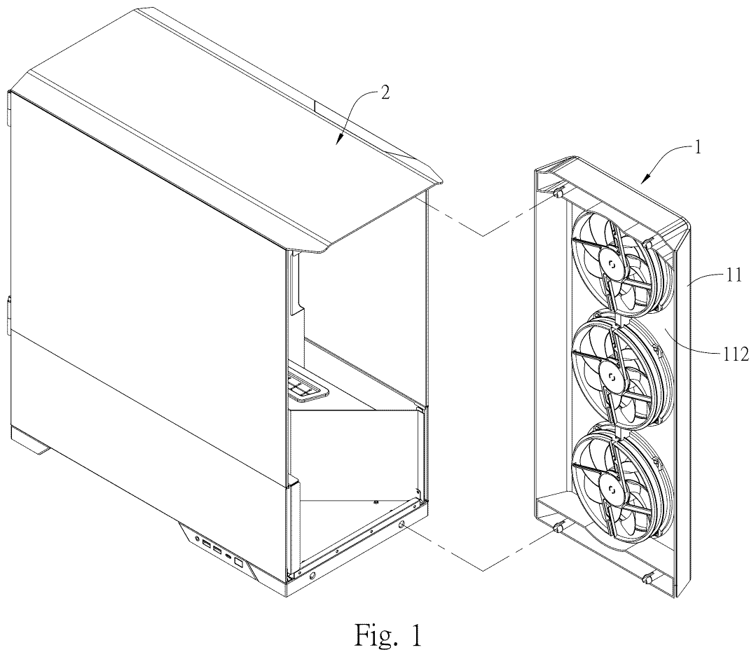

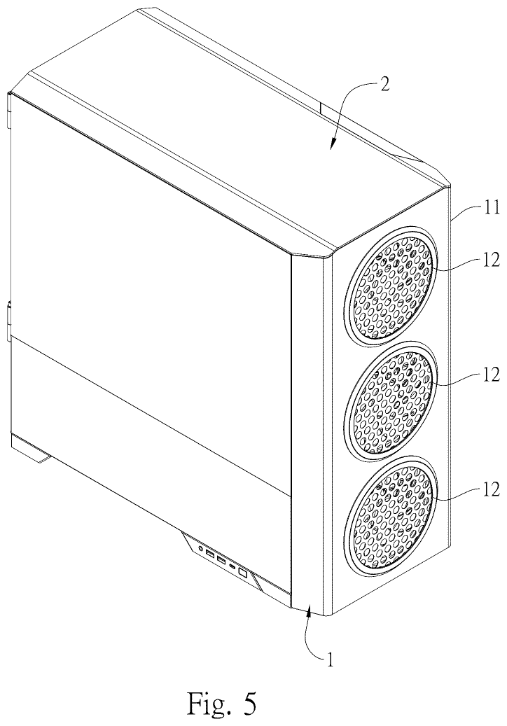

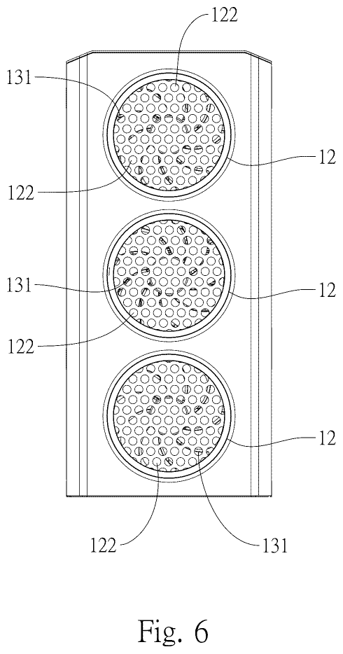

With reference to FIGS. 1 to 6, a front panel structure 1 of a computer case 2 according to an embodiment of the present invention is configured to be assembled and integrated with a front side of the computer case 2 to form a computer case structure. The front panel structure 1 of the computer case 2 mainly consists of a light-transmissive panel body 11, a plurality of covers 12, and a cooling fan module 13.

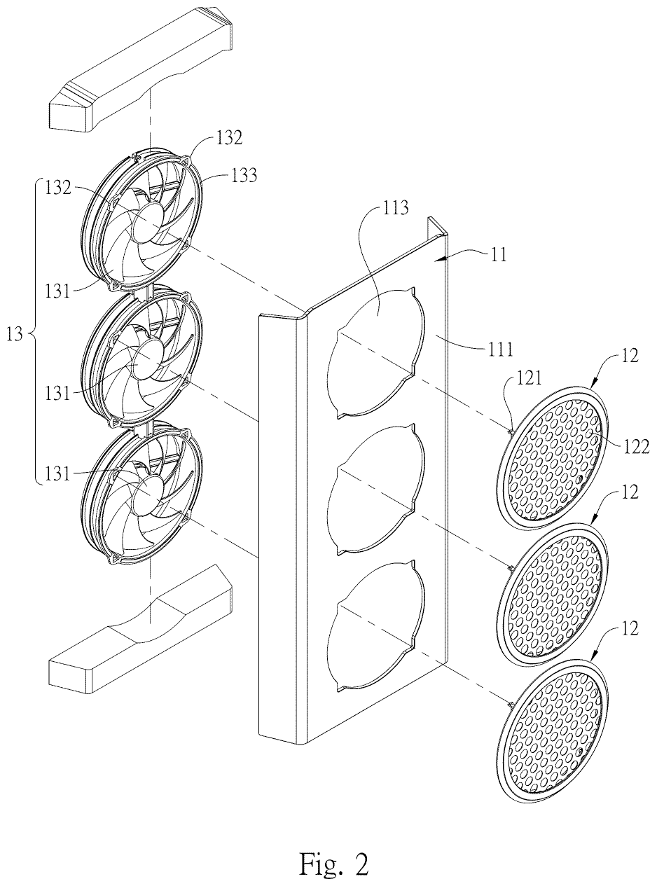

As shown in FIGS. 1 and 2, the light-transmissive panel body 11 has an outer surface 111 and an inner surface 112, and is provided with a plurality of through holes 113. Each through hole 113 penetrates the outer surface 111 and the inner surface 112 of the light-transmissive panel body 11.

The plurality of covers 12 respectively close each of the through holes 113 on the outer surface 111 of the light-transmissive panel body 11, and a diameter of each cover 12 is greater than a diameter of each through hole 113 to allow each cover 12 to fully shield its corresponding through hole 113. Each of the covers 12 is provided with a plurality of fastening members 121 on the periphery, and each cover 12 is disposed a plurality of ventilation holes 122 thereon.

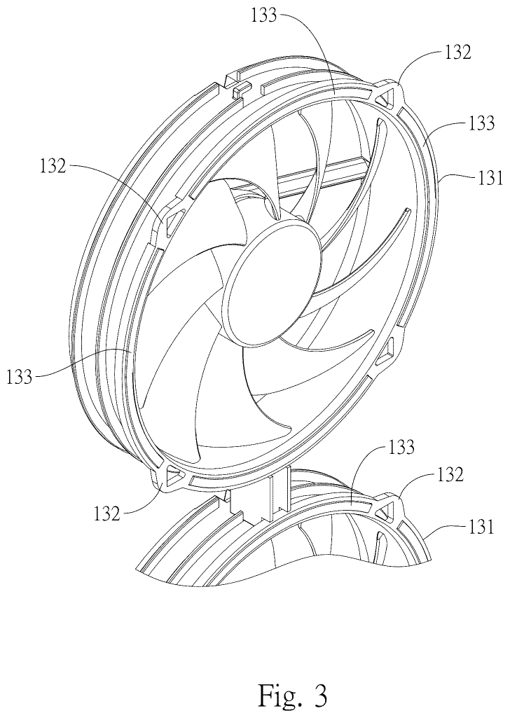

The cooling fan module 13 has a plurality of cooling fans 131, and each of the cooling fans 131 is sequentially located on the inner surface 112 of the light-transmissive panel body 11 and respectively aligned opposite each of the through holes 113. Each cooling fan 131 is disposed with a plurality of fastening portions 132 on a lateral side of the inner surface 112 of the light-transmissive panel body 11. Additionally, an elastic member 133 (as shown in FIG. 3) is provided between each fastening portion 132 of each cooling fan 131, and when each cooling fan 131 is mounted on the inner surface 112 of the light-transmissive panel body 11, the elastic members 133 could closely attach to the inner surface 112 of the light-transmissive panel body 11 surrounding the through holes 113.

In the design of the light-transmissive panel body 11 of this embodiment, the fastening portions 132 of each cooling fan 131 are holes, and the fastening members 121 of each cover 12 are hooks. Certainly, the coupling method for these portions is not limited to the aforementioned coupling. For example, by providing mutually magnetic materials for the fastening portions 132 and the fastening members 121, or through other mutually engaging mechanical designs, the objective of allowing the cover 12 to be detachably and securely coupled to the cooling fan 131 can also be achieved.

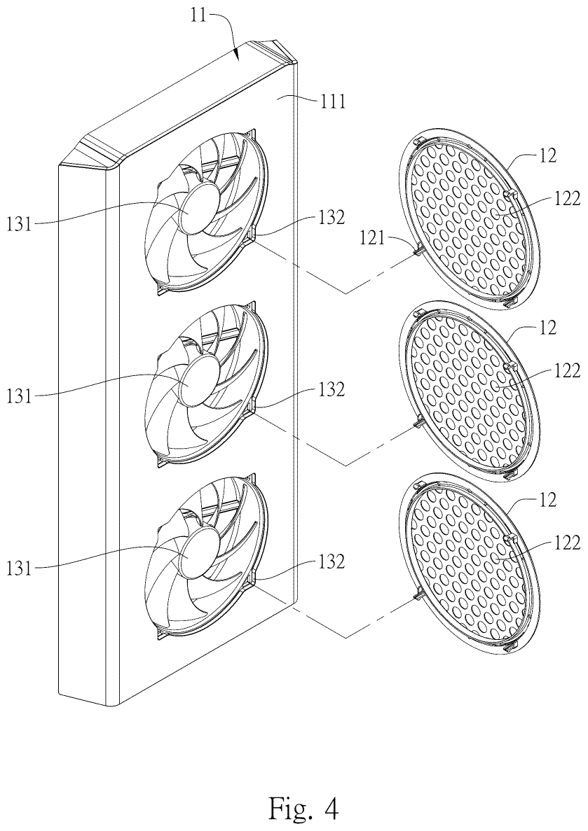

Therefore, in implementation, when the fastening members 121 of each cover 12 are securely connected to the fastening portions 132 of the cooling fan 131 on another side of the through hole 113, as the diameter of each cover 12 is greater than the diameter of each through hole 113, and the elastic members 133 of each cooling fan 131 could closely attach to the inner surface 112 of the light-transmissive panel body 11 surrounding the through holes 113, the cover 12 and the cooling fan 131 will not tilt outwardly or inwardly and fall off after the cover 12 is coupled to the cooling fan 131, such that the cooling fans 131 and the covers 12 could be stably positioned on the light-transmissive panel body 11 to allow airflow generated by the cooling fans 131 after starting to flow in and out through the through holes 113 and the ventilation holes 122, thereby forming a heat dissipation channel within the light-transmissive panel body 11 on the front side of the computer case 2 (as shown in FIGS. 4 to 6).

Accordingly, the present invention has the following advantages:
1. Through the design of this invention, a panel with airflow channels can be formed on the front side of the computer case. This provides additional heat dissipation pathways beyond the conventional rear exhaust of the computer case, so that the heat accumulated inside the computer case can be exhausted quickly and effectively.
2. The present invention utilizes a front-mounted design to conceal the cooling fan within the light-transmissive panel body to form a simple and concise structure design. The quick-release designs of the front-mounted cover on the light-transmissive panel body and the rear-mounted cooling fans enable more convenient and rapid assembly or replacement. The design featuring a light-transmissive panel body offers consumers a distinct visual experience, thereby enhancing the competitiveness of computer case sales.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

In summary, as disclosed in the above description and attached drawings, the present invention can indeed achieve the expected object by providing a front panel structure of a computer case, which is of great practicality and industrial value.

1. A front panel structure of a computer case, configured to be assembled with a front side of the computer case to form a computer case structure, the front panel structure comprising:
a light-transmissive panel body having an outer surface and an inner surface, the panel body being provided with a plurality of through holes, each of the through holes penetrating the outer surface and the inner surface of the panel body;
a plurality of covers for respectively closing each of the through holes on the outer surface of the light-transmissive panel body, each of the covers being provided with a plurality of fastening members and a plurality of ventilation holes; and
a cooling fan module having a plurality of cooling fans, wherein each of the cooling fans is sequentially located on the inner surface of the light-transmissive panel body and respectively aligned opposite each of the through holes, and wherein each cooling fan is disposed with a plurality of fastening portions on a lateral side of the inner surface of the light-transmissive panel body, so that when the fastening members of each cover are securely connected to the fastening portions of the cooling fan on another side of the through hole, the cooling fans and the covers are stably positioned on the light-transmissive panel body to allow airflow generated by the cooling fans after starting to flow in and out through the through holes and the covers.

2. The front panel structure of the computer case according to claim 1, wherein the fastening portions of each cooling fan are holes, and the fastening members of each cover are hooks.

3. The front panel structure of the computer case according to claim 1, wherein an elastic member is provided between each fastening portion of the cooling fan, and when each cooling fan is mounted on the inner surface of the light-transmissive panel body, the elastic members closely attach to the inner surface of the light-transmissive panel body surrounding the through holes.

4. The front panel structure of the computer case according to claim 1, wherein a diameter of each cover is greater than a diameter of each through hole.
